(19) United States
(12) Patent Application Publication
(10) Pub. No.: US 2014/0327793 A1
(43) Pub. Date: Nov. 6, 2014

(54) Imaging Apparatus and Method Comprising Imager and Optics Actuator Means

(71) Applicants: Itzhak Sapir, Irvine, CA (US); Medhat Azzazy, Laguna Niguel, CA (US)

(72) Inventors: Itzhak Sapir, Irvine, CA (US); Medhat Azzazy, Laguna Niguel, CA (US)

(21) Appl. No.: 13/875,037

(22) Filed: May 1, 2013

(51) Int. Cl. H04N 5/232; G02B 7/04

(52) U.S. Cl. CPC H04N 5/23212; G02B 7/04
USPC 348/218.1; 348/357

(57) ABSTRACT

An imaging device and method of providing an increased depth-of-field of an electronic image. The image sensor and the optical lens assembly are selectively repositionable along the optical axis of the lens using electronic actuator elements such as piezo-electric actuator elements, A plurality of images of a scene are captured while the image sensor, the optical lens assembly, or both are positioned at predetermined locations along the optical axis. Selected elements of each of the images captured using different focal planes are electronically combined to define a final image having an increased depth-of-field.

### CROSS-REFERENCE TO RELATED APPLICATIONS

This application claims the benefit of U.S. Provisional Patent Application No. 61/644,132, filed on May 8, 2012, entitled “Method and Apparatus for Infinite Focus Imaging”, and, U.S. Provisional Patent Application No. 61/772,636, filed on Mar. 5, 2013, entitled “Imaging Apparatus Comprising Imager and Optics Actuator Mean to Increase Depth of Field”, pursuant to 35 USC 119, which applications are incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic imaging devices. More specifically, the invention relates to an electronic imaging device and method that uses image sensor and optics positioning means for repositioning the sensor and optics along, a camera's optical axis whereby a sequence of images captured having different depths-of-field may he combined to provide an increased depth-of-field of a final image.

2. Description of the Related Art

In photography, the depth-of-field of an image is determined by the scene portions in an image that are in front of and behind the focus point (or focal plane) and that remain in focus in the final image. This element of an image tends to be larger in landscape photography and smaller in macro-photography. It is dependent upon the focusing distance, focal length of the lens, the f-number being used and other optical settings.

Once an image of a scene is acquired in an electronic imaging device such as a camera, elements in the scene that not in focus cannot later be brought into focus. In some cases, especially in macro-photography, the depth-of-field is restrictively narrow from an artistic standpoint and desirably needs to be increased.

A prior art approach used for increasing the depth-of-field in imaging technology is acquiring a sequence of separate images, each with different focal points along the Z direction or optical axis (distance from the camera lens), but each having substantially the same composition, and then combining those images or selected pixels from the plurality of images into a single final image. This is sometimes referred to as “image stacking” and various software programs are commercially available that perform such image stacking operations.

The prior art method by which the sequence of interim images are acquired generally comprises the steps of making small manual focus adjustments using the lens' focusing ring while the camera is fixedly mounted on a tripod and then acquiring a scene image at each adjustment step.

An undesirable aspect of this prior art approach is that when using the lens for foot using to different distances, the scene coverage changes slightly by inducing a minor zooming effect in each individual image. The result is a small mismatch between each of the images that comprise the sequence of images and therefore reduced quality of the final image. Beneficially, in the method of the instant invention, all of the images in the sequence have substantially the same scene coverage since there is no substantial change in the optical system elements.

Another prior art approach that uses multiple scene images for increased depth-of-field has been introduced by Lytro, Inc. and uses a specialized camera device that captures different light traces to permit post-processing and re-focusing of the captured image to any point selected by the user. Unfortunately, this method has a relatively high cost that is not found in low-cost approach of the instant invention.

The instant invention also permits automating the prior art methods presented above in a way that can be used in existing and new digital and film cameras. The instant invention may be embodied, for instance, in the digital cartridge insert inventions for film cameras disclosed in, for instance, U.S. Pat No, 5,282,040, “Apparatus for Operating a Film Camera”, to Sapir, Applicant herein, U.S. Pat. No. 5,452,000, “Apparatus for Electronic Photography Using Conventional Film Camera” to Sapir, Applicant herein, U.S. Pat. No. 6,147,389, “Image Sensor Package with Image Plane Reference” to Stern et al. or U.S. Pat. No. 6,393,224, “E-Film Cartridge With Sensor Avoidance Feature” to Stern et al., the entirety of each of which is incorporated herein by reference.

To address the needs and deficiencies in the prior art, the imaging device of the invention addresses the desirable increased depth-of-field in the prior art devices but is simple, mechanically reliable and lower-cost than prior art devices and methods.

### BRIEF SUMMARY OF THE INVENTION

The invention comprises an imaging apparatus and method incorporating image sensor and optics actuator means configured to provide an increased depth-of-field in a final image.

In a first aspect of the invention, a device for providing an increased depth-of-field in an electronic image is disclosed comprising an electronic image sensor, an optical lens assembly having an optical axis and configured to focus a scene image on the image sensor and an actuator configured to selectively position the image sensor at a plurality of predetermined positions along the optical axis during multiple scene image acquisition.

In a second aspect of the invention, a device tor providing an increased depth-of-field in an electronic image is disclosed comprising an electronic image sensor, an optical lens assembly having an optical axis and configured to focus a scene image on the image sensor and an actuator configured to selectively position the optical lens assembly at a plurality of predetermined positions along the optical axis during multiple scene image acquisition.

In a third aspect of the invention, a device for providing an increased depth-of-field in an electronic image is disclosed comprising an electronic image sensor, an optical lens assembly having an optical axis and configured to focus a scene image on the image sensor, and, at least two actuators configured to independently and selectively position the optical lens assembly and image sensor at a plurality of predetermined positions along the optical axis during multiple scene image acquisition.

In a fourth, aspect of the invention, at least one of the actuators may be a piezo-electric actuator element.

In a fifth aspect of the invention, at least one of the actuators may be a MEMS-fabricated actuator element such as an electrostatically-driven comb drive element.

In a sixth aspect, of the invention, at least one of the actuators may be an electromagnetically-driven actuator element.

In a seventh aspect of the invention, a method for providing an electronic image having an increased depth-of-field is disclosed comprising the steps of capturing a first electronic image of a scene using an optical lens assembly and an electronic image sensor, repositioning the linage sensor or the optical lens assembly along an optical axis of the optical lens assembly, capturing a second electronic image of the scene using the optical lens assembly and the electronic image sensor and combining selecting portions of the first electronic image and the second electronic image to define a final scene image comprising predetermined elements of the first and second image portions.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope, of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a preferred embodiment of the imaging device of the invention showing the optical lens assembly and image sensor elements that are repositionable along the optical axis of the lens during multiple scene image acquisition by means of actuator elements.

The invention and its various embodiments can now be better understood by turning to the following detailed description of the preferred embodiments which are presented as illustrated examples of the invention defined in the chums.

it is expressly understood that the invention as defined by the claims may be broader than the illustrated embodiments described below.

### DETAILED DESCRIPTION OF THE INVENTION

An imaging device and method for providing an increased depth-of-field of an electronic image is disclosed.

The image sensor and the optical lens assembly are selectively repositionable along the optical axis of the lens using electronic actuator elements such as piezoelectric elements. A plurality of images of a scene are captured while the image sensor, the optical lens assembly, or both, are repositioned at predetermined locations along the optical axis. Selected elements or pixel sets of each of the images captured using different focus points are electronically combined to define a final image having an increased depth-of-field.

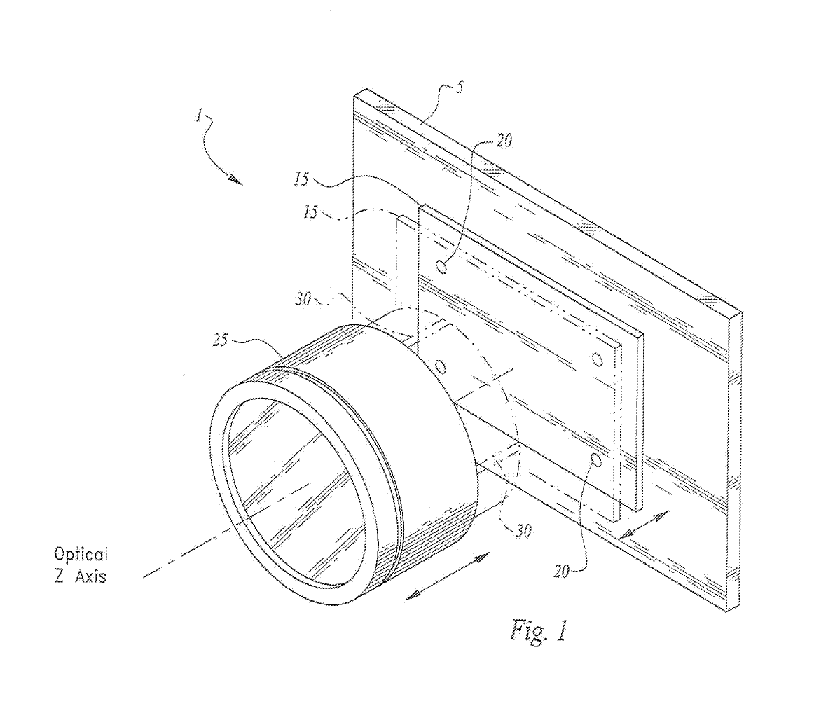

Turning to FIG. 1, the method and device of the instant invention increases the depth-of-field of a final image from a set of Images from an electronic imager, such as in a digital camera, by mounting or disposing an electronic image sensor, an optical lens assembly, or both, on one or more Z-actuator drive elements, i.e., one or more actuator elements that selectively reposition or displace the image sensor, the optical lens assembly, or both along the device's optical or Z-axis at one or more predetermined Z-axis positions.

The device 1 may generally be comprised of a camera back or mounting plane 5, an image sensor 15, which may provided as a CCD, CMOS, micro-bolometer or any desired imager focal plane array.

Device 1 may farther comprise one or more image sensor actuator elements 20, an optical lens assembly 25 and one or more optical lens assembly-actuator elements 30.

As depicted in FIG. 1, device 1 is provided so that after achieving an image focus at a predetermined focal plane on image sensor 15, the orientation of the device elements may be configured to capture a sequence of images using one or more actuators configured so as to move or displace image sensor 15 (using image sensor actuators 20), optical lens assembly 25 (using optical assembly actuator elements 30), or both, along the lens' optical Z-axis at any position from a focal plane behind the initial focal plane of image sensor 15 to a focal plane in front of the initial focal plane of image sensor 15.

In a preferred embodiment of the invention, rather than selectively displacing Image sensor 15 along the Z-axis of the invention to achieve, a focus in a scene image, the actuators of the invention are provided to reposition optical lens assembly 25 to redefine the focal plane of device 1.

In this embodiment, the focusing process steps may be. but are not limited to, being performed relative to the movement of the optical components inside the optical lens assembly 25, but rather may also be accomplished by moving the optical lens assembly 25 itself

In an alternative preferred, embodiment, suitable actuator and drive circuitry may be provided such that both optical lens assembly 25 and image sensor 15 focal plane array are cooperatively and independently driven and repositioned along the Z-axis at predetermined positions to achieve increased depth-of-field of a final image from a sequence of images acquired at the predetermined positions.

The actuator of the invention for positioning image sensor 15, optical lens assembly 25, or both, along the Z-axis of the lens may be a piezo-electric actuator comprised of a single layer plate or a multiple layer stack.

An exemplar piezo-electric actuator for use in any of the above embodiments may comprise, for instance, a PICMA Chip Actuator as is available from Physik Instrumente (PI) GmbH & Co. The relatively small size and power requirement of this form of “piezo-actuator” (e.g. 2×2×2 mm) make them well-suited for the above application and is capable of providing sub-nanometer resolution along with sub-millisecond response times.

In the alternative, a MEMS actuator element configured for positioning image sensor 15 focal plane, optical lens assembly 25, or both, along the Z-axis at a plurality of predetermined positions are within the scope of the invention.

The actuators of the invention may also be embodied in a MEMS-fabricated micro-actuator such as in the form of an electrostatically-driven MEMS actuator provided in a MEMS “comb drive” configuration which may comprise an interleaved set of MEMS plates driven by varying the voltage difference (sometimes referred to as “electrostatic”) between the plate sets.

The actuator of the invention may be provided in the form of an electromagnetic actuator using a coil and metal core element such as a voice coil element.

The final scene image having an increased depth-of-field may be assembled from device 1 using selected portions or pixel sets that are “sampled” or “donated” and assembled from the sequence of images captured by the multiple images and combined into a final single image using suitable software, each pixel set selected as having predetermined characteristics (such as focus or depth-of-field characteristics).

A final scene image may be assembled by combining selected portions or pixel sets from selected ones of the sequence of images captured at predetermined positions along the Z-axis of the focal plane of the image sensor, using, for instance, suitable image processing algorithms executed in suitable electronic circuitry, which may be on-board or off-board device 1 of the invention.

The incremental image sensor 15 or optical lens assembly 25 actuator “step” distance, number of scene images and total depth-of-field coverage may be selectively electronically controlled or is adjustable by the user prior to acquiring the images using suitable electronic control circuitry.

An exemplar set of Z-axis incremental image sensor 15 or optical lens assembly 25 distance steps may be, but are not limited to, a sequence of images acquired at 0.05 mm steps and having a total Z-axis displacement of 1.0 mm, comprising a set of 20 frames of interim image data, each having a different depth-of-field for combining selected portions thereof into a final scene image.

Many alterations and modifications may he made by those having ordinary skill in the art without departing from the spirit and scope of the invention. Therefore, it must be understood that, the illustrated embodiment has been set forth only for the purposes of example and that it should not be taken as limiting the invention as defined by the following claims. For example, notwithstanding the fact that the elements of a claim are. set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from, a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A device for providing an increased depth-of-field in an electronic image comprising:
an electronic image sensor,
an optical lens assembly having an optical axis and configured to focus a scene image on the image sensor, and,
an actuator configured to selectively position the image sensor at a plurality of predetermined positions along the optical axis.

2. The device of claim 1 wherein the actuator comprises a piezo-electric actuator element.

3. The device of claim 1 wherein the actuator comprises a MEMS-fabricated actuator element.

4. The device of claim 1 wherein the actuator comprises an electromagnetic actuator element.

5. A device for providing an increased depth-of-field in an electronic image comprising:
an electronic image sensor,
an optical lens assembly having an optical axis and configured to focus a scene image on the image sensor, and,
an actuator configured to selectively position the optical lens assembly at a plurality of predetermined positions along the optical axis.

6. The device of claim 5 wherein the actuator comprises a piezo-electric actuator element.

7. The device of claim 5 wherein the actuator comprises a MEMS-fabricated actuator element.

8. The device of claim 5 wherein the actuator comprises an electromagnetic actuator element.

9. A device for providing an increased depth-of-field in an electronic image comprising:
an electronic image sensor,
an optical lens assembly having an optical axis and configured to focus a scene image on the image sensor, and,
at least two actuators configured to independently and selectively position the optical lens assembly and image sensor at a plurality of predetermined positions along the optical axis.

10. The device of claim 9 wherein at least one of the actuators comprises a piezo-electric actuator element.

11. The device of claim 9 wherein at least one the actuators comprises a MEMS-fabricated actuator element.

12. The device of claim 9 wherein at least one of the actuators comprises an electromagnetic actuator element.

13. A method for providing an electronic image having an increased depth-of-field comprising the steps of:
capturing a first electronic image of a scene using an optical lens assembly and an electronic image sensor,
repositioning the image sensor or the optical lens assembly along an optical axis of the optical lens assembly using an actuator,
capturing a second electronic image of the scene using the optical lens assembly and the electronic image sensor, and,
combining selecting portions of the first electronic image and the second electronic image to define a final scene image.
